(19) United States
(12) Patent Application Publication
(10) Pub. No.: US 2013/0262654 A1
(43) Pub. Date: Oct. 3, 2013

(54) RESOURCE MANAGEMENT SYSTEM WITH RESOURCE OPTIMIZATION MECHANISM AND METHOD OF OPERATION THEREOF

(71) Applicants: Hans Masli, Milpitas, CA (US); Chuen-Chien Lee, Pleasanton, CA (US); Alexander Berestov, San Jose, CA (US); Tomofumi Okuda, Cupertino, CA (US); Jeremy Saltzman, Sunnyvale, CA (US)

(72) Inventors: Hans Masli, Milpitas, CA (US); Chuen-Chien Lee, Pleasanton, CA (US); Alexander Berestov, San Jose, CA (US); Tomofumi Okuda, Cupertino, CA (US); Jeremy Saltzman, Sunnyvale, CA (US)

(73) Assignee: Sony Corporation, Tokyo (JP)

(21) Appl. No.: 13/432,598

(22) Filed: Mar. 28, 2012

(51) Int. Cl. G06F 15/173

(52) U.S. Cl. 709/224

(57) ABSTRACT

A method for operating a resource management system includes: identifying a total-usage status of a resource currently being supplied; calculating a current production amount of supplying the resource using the total-usage status; calculating an assessment structure directly reflecting the current production amount; adjusting the assessment structure for modifying behavior associated with the current consumption of the resource.

### CROSS-REFERENCE TO RELATED APPLICATION(S)

The present application contains subject matter related to a concurrently filed U.S. patent application by Hans Masli, Chuen-Chien Lee, Alexander Berestov, Tomofumi Okuda, and Jeremy Saltzman entitled “BUILDING MANAGEMENT SYSTEM WITH PRIVACY-GUARDED ASSISTANCE MECHANISM AND METHOD OF OPERATION THEREOF”. The related application is assigned to Sony Corporation and is identified by docket number 1014-055. The subject matter thereof is incorporated herein by reference thereto.

### TECHNICAL FIELD

The present invention relates generally to a resource management system, and more particularly to a resource management system with sensors.

### BACKGROUND ART

As technology advances, users become more empowered and new and old paradigms begin to take advantage of these advancements. Advances in communication, computing, and sensory technology are providing increasing levels of functionality to support modern life including energy conservation and home management.

The ever increasing need for conserving resources, both on global and personal levels, requires users to consider different uses for the tools and services in their daily routines. Users are willing to change their habits and routines to better conserve resources, such as electricity or money. Further, the increasing accessibility of information makes it possible for people to maximize the value of all their resources.

Thus, a need still remains for resource management system with resource optimization mechanism. In view of the diminishing resources and increased desired for safety and accommodation, it is increasingly critical that answers be found to these problems. In view of the ever-increasing commercial competitive pressures, along with growing consumer expectations and the diminishing opportunities for meaningful product differentiation in the marketplace, it is critical that answers be found for these problems. Additionally, the need to reduce costs, improve efficiencies and performance, and meet competitive pressures adds an even greater urgency to the critical necessity for finding answers to these problems.

Solutions to these problems have been long sought but prior developments have not taught or suggested any solutions and, thus, solutions to these problems have long eluded those skilled in the art.

### DISCLOSURE OF THE INVENTION

The present invention provides a method for operating a resource management system including: identifying a total-usage status of a resource currently being supplied; calculating a current production amount of supplying the resource using the total-usage status; calculating an assessment structure directly reflecting the current production amount; and adjusting the assessment structure for modifying behavior associated with the current consumption of the resource.

The present invention provides a resource system including: a current-total module for identifying a total-usage status of a resource currently being supplied; a current-cost module, coupled to the current-total module, for calculating a current production amount of supplying the resource using the total-usage status; a cost reflection module, coupled to the current-cost module, for calculating an assessment structure directly reflecting the current production amount; and a demand management module, coupled to the current-cost module, for adjusting the assessment structure for modifying behavior associated with the current consumption of the resource.

Certain embodiments of the invention have other aspects in addition to or in place of those mentioned or obvious from the above. The aspects will become apparent to those skilled in the art from a reading of the following detailed description when taken with reference to the accompanying drawings.

### BRIEF DESCRIPTION OF THE DRAWINGS

FIG. 1 is a resource management system with resource optimization mechanism in an embodiment of the present invention.

FIG. 2 is an example of a supplier display interface on the second device.

FIG. 3 is an example of one of the client structures of FIG. 1.

FIG. 4 is an example of a detailed consumption data of one of the client structures of FIG. 1.

FIG. 5 is an exemplary block diagram of the resource management system.

FIG. 6 is a control flow of the resource management system.

FIG. 7 is a flow chart of a method of operation of the resource management system in a further embodiment of the present invention.

### BEST MODE FOR CARRYING OUT THE INVENTION

The following embodiments are described in sufficient detail to enable those skilled in the art to make and use the invention. It is to be understood that other embodiments would be evident based on the present disclosure, and that system, process, or mechanical changes can be made without departing from the scope of the present invention.

In the following description, numerous specific details are given to provide a thorough understanding of the invention. However, it will be apparent that the invention can be practiced without these specific details. In order to avoid obscuring the present invention, some well-known circuits, system configurations, and process steps are not disclosed in detail.

Likewise, the drawings showing embodiments of the system are semi-diagrammatic and not to scale and, particularly, some of the dimensions are for the clarity of presentation and are shown greatly exaggerated in the drawing FIGs. Similarly, although the views in the drawings for ease of description generally show similar orientations, this depiction in the FIGs. is arbitrary for the most part. Generally, the invention can be operated in any orientation.

In addition, where multiple embodiments are disclosed and described having some features in common, for clarity and ease of illustration, description, and comprehension thereof, similar and like features one to another will ordinarily be described with like reference numerals.

The term “module” referred to herein can include software, hardware, or a combination thereof in the present invention in accordance with the context in which the term is used. For example, the software can be machine code, firmware, embedded code, and application software. Also for example, the hardware can be circuitry, processor, computer, integrated circuit, integrated circuit cores, a camera sensor, a motion sensor, a temperature and humidity sensor, a storage device, resource generation device, a pressure sensor, an inertial sensor, a microelectromechanical system (MEMS), passive devices, or a combination thereof.

The term “processing” as used herein includes assembling data structures, transferring data structures to peripheral storage devices, manipulating data structures, and reading data structures from external sources. Data structures are defined to be files, input data, system generated data, such as calculated data, and program data.

The term “cost” as used herein is defined as the expenditure required for the suppliers, such as power plants or utility companies, to supply the resources to the consumers. For example, the cost can be financial expenditure or the expenditure amount of the natural resource, such as coal, water or gas, associated with supplying the resource. Also, for example, the cost can be the administrational and operational cost to provide a desired amount of resource or electricity or the barrel price of crude oil.

The term “price” as used herein is defined as the assessed value of the amount of resources supplied to or used by the consumer. For example, the price can be expressed through monetary value for the resource, such as the electricity price or the gas price paid by the consumers, or through a point or allowance system.

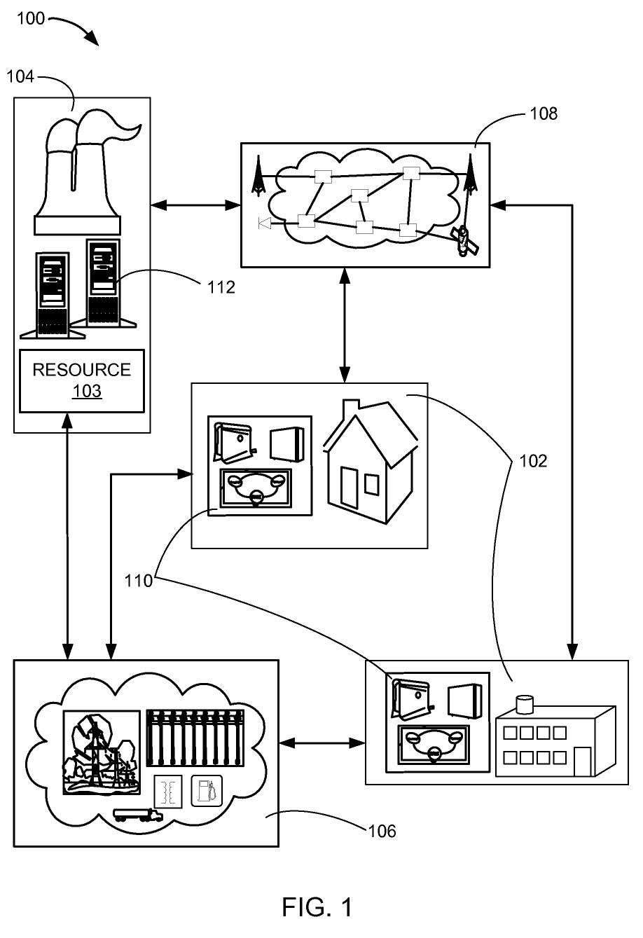

Referring now to FIG. 1, therein is shown a resource management system 100 with resource optimization mechanism in an embodiment of the present invention. The resource management system 100 can include client structures 102, a resource supplier 104, a resource distribution network 106, and a communication network 108.

The client structures 102 are defined as recipients and consumers of a resource 103. The client structures 102 can be end users and consumers of the resource 103, such as energy or natural resources. For example, the client structures 102 can include residences, smart homes or structures, businesses, manufacturing facilities, recreational units, or a combination thereof.

Also for example, the client structures 102 can be a residential community, a business plaza, a city block, a district, a city, a county, a state, or a combination thereof. For further example, the client structures 102 can consume electricity, gasoline, natural gas, water, or a combination thereof.

Each of the client structures 102 can have a first device 110. The first device 110 is defined as a single unit device or a device having multiple portions or units that detects, calculates, alerts, and controls the usage of the resource 103 at each of the client structures 102. The first device 110 can be coupled to the resource distribution network 106, the communication network 108, or both. Details regarding the first device 110 will be discussed below.

The client structures 102 can receive the resource 103 from the resource supplier 104. The resource supplier 104 is defined as a producer or distributor of energy or natural resources. For example, the resource supplier 104 can be a power plant, a utility company, a refinery, or a gas station.

The resource supplier 104 can have a second device 112. The second device 112 is defined as a single unit device or a device having multiple portions or units that detects, calculates, alerts, and controls the distribution of the resource 103 at the resource supplier 104. The second device 112 can be coupled to the resource distribution network 106, the communication network 108, or both. Details regarding the second device 112 will be discussed below.

The resource supplier 104 can provide the client structures 102 with the resource 103 through the resource distribution network 106. The resource distribution network 106 is defined as a way of transporting, supplying, or availing the resource 103 to the client structures 102.

For example, the resource distribution network 106 can include a power distribution network having a network of distribution lines, transformers, and transmission stations, or a network of connected gas pipes. Also, for example, the resource distribution network 106 can be a shipping or a trucking service for delivering gasoline to local suppliers.

The resource supplier 104 and the client structures 102 can also be connected through the communication network 108. The communication network 108 is defined as a coupled set or sets of communication equipment and medium used for communicating between the client structures 102 and the resource supplier 104. For example, the communication network 108 can include telephone landlines, data lines, wireless communication networks, or a combination thereof.

For illustrative purposes, the communication network 108 and the resource distribution network 106 are described as two separate networks. However, it is understood that the two functions of the networks can simultaneously exist within one network. For example, power distribution lines or a system of wireless transmitters and receivers can simultaneously carry electricity and data signals between the resource supplier 104 and the client structures 102.

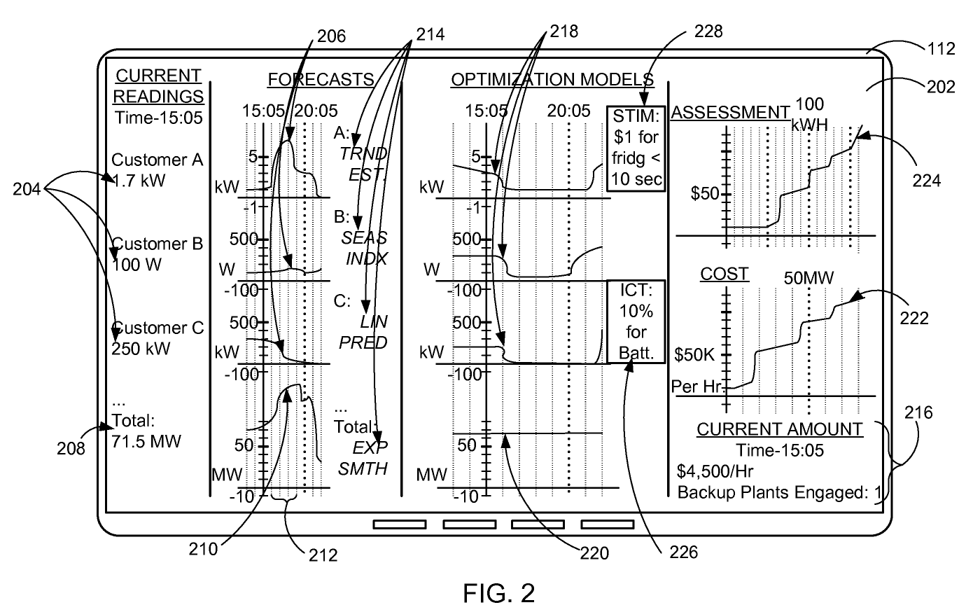

Referring now to FIG. 2, therein is shown an example of a supplier display interface 202 on the second device 112. The supplier display interface 202 can show a client-usage status 204, a client-usage forecast 206, a total-usage status 208, and a total-usage forecast 210.

The client-usage status 204 is defined as the current usage or consumption of the resource 103 of FIG. 1 at each of the client structures 102 of FIG. 1. The client-usage status 204 can be the rate of usage based on time. For example, the client-usage status 204 can indicate the wattage of the electricity currently being used at each of the client structures 102 or the current gas consumption amount and rate for a building that is one of the client structures 102.

The client-usage forecast 206 is defined as the predicted usage or consumption of the resource 103 at each of the client structures 102. The client-usage forecast 206 can be the predicted rate of usage determined for a future time based on past usage, user profile and preferences, seasonal usage patterns, status of the first device 110 of FIG. 1, user opt-in or participation in a program, subscription plan, storage device, supplemental or backup resource production device, weather forecast, time of day, or any combination thereof. For example, the client-usage forecast 206 can be represented by a graph of predicted gas usage levels over time at a residence or an averaged usage of water for a factory for a period of time.

The resource management system 100 can determine and use the client-usage forecast 206 in a variety of ways. The details regarding the determination and the application of the client-usage forecast 206 will be discussed below.

The total-usage status 208 is defined as the current total of the resource 103 demanded from the resource supplier 104 of FIG. 1. The total-usage status 208 can be the sum of the client-usage status 204 for all of the client structures 102 being served or supplied by the resource supplier 104.

The total-usage forecast 210 is defined as the predicted amount of the resource that will be demanded from the resource supplier 104 at a specific time or over a period of time. The total-usage forecast 210 can be the sum of the client-usage forecast 206 for all of the client structures 102 being served or supplied by the resource supplier 104.

The total-usage forecast 210 can have predicted amounts corresponding to groupings of the client structures 102. For example, the total-usage forecast 210 can include the anticipated amount of consumption for the resource 103 for a community, a neighborhood, a city, a county, a state, or a combination thereof. The total-usage forecast 210 can include different sums of the client usage forecast 206 corresponding to each of the client structures within each of the groupings.

The resource management system 100 can determine and use the total-usage forecast 210 in a variety of ways. The details regarding the determination and the application of the total-usage forecast 210 will be discussed below.

The total-usage forecast 210 can have a peak-period 212. The peak-period 212 is defined as the period of time surrounding the time at which the usage rate is the highest. For example, the peak-period 212 can be from 5:00 pm to 7:00 pm, where the electricity usage is at the highest point within a day. Also, the peak-period 212 can be during the summer months for electricity or surrounding a popular vacation period or family oriented holidays, when gasoline consumption is the highest within a year.

The client-usage forecast 206 and the total-usage forecast 210 can be determined using a forecast model 214. The forecast model 214 is defined as a method for forecasting and determining the future usage of the resource 103. For example, the forecast model 214 can be Delphi, market research, historical method, last period demand, moving average, exponential smoothing, multiplicative seasonal indexes, linear prediction, trend estimation, or any combination of methods or processes thereof.

The supplier display interface 202 can also show a current production amount 216, a client-optimization model 218, a total-optimization model 220, a cost profile 222, and an assessment structure 224. The current production amount 216 is defined as the current cost for the resource supplier 104 to supply the resource 103 to the client structures 102.

The current production amount 216 can be represented as units of resource such as kilowatt-hour (kwh) for electricity, monetary amount, time, labor hours, supplies, or any combination thereof. For example, the current production amount 216 can be the current reflection of the operating cost of a water supplier or the number of back-up power plants being used to serve the current need for electricity.

The client-optimization model 218 is defined as a usage method for each of the client structures 102 that best optimize the cost for the user. For example, the client-optimization model 218 can be the electricity usage plan, outlined as kwh that would yield the lowest monthly bill for the user. Also, for example, the client-optimization model 218 can be the speed or acceleration profile for a vehicle that yields the highest miles-per-gallon for a unit of gasoline.

The resource management system 100 can calculate and use the client-optimization model 218 in a variety of ways. The details regarding the calculation and the application of the client-optimization model 218 will be discussed below.

The total-optimization model 220 is defined as a production method for the resource supplier 104 that best optimizes the cost of supplying the resource 103 to the client structures 102. For example, the total-optimization model 220 can be the operation schedule for a network of power plants to generate electricity while minimizing the operation cost of the power company. Also, for example, the total-optimization model 220 can be the water release rate of the dam that best conserves the water.

The resource management system 100 can calculate and use the total-optimization model 220 in a variety of ways. The details regarding the calculation and the application of the total-optimization model 220 will be discussed below.

The cost profile 222 is defined as the cost necessary to produce differing amounts of the resource 103. For example, the cost profile 222 can be represented by a graph that shows the total output amount of electricity on the x-axis and the amount of money required to produce such amount for the power company on the y-axis.

The cost profile 222 can reflect steady rise proportionate to the increase in demand. The cost profile 222 can also reflect steep inclines where additional sources and suppliers become necessary to meet the demand.

The assessment structure 224 is defined as the price of the resource 103 consumed by the consumers. The assessment structure 224 can be calculated based on time or amount of usage, user profile or history, the client-usage forecast 206, the total-usage forecast 210, status of the first device 110, the second device 112, or the resource supplier 104, the client-optimization model 218, the total-optimization model 220, or any combination thereof.

The assessment structure 224 can be based on the cost profile 222, the total-optimization model 220, the client-optimization model 218, the client-usage forecast 206, the total-usage forecast 210, or any combination thereof. The assessment structure 224 can thus be dynamic and directly reflect the cost profile 222 and optimize the usage and the price based on the market demand and the cost to meet such demand.

The assessment structure 224 can also be used to serve as a motivation used to adjust consumer behavior and the resulting demand such that the total-usage status 208 conforms to the total-optimization model 220. To manage the demand and assist the consumers, the client-optimization model 218 can be used to drive the client-usage status 204 toward the client-optimization model 218.

The resource management system 100 can calculate and use the assessment structure 224 in a variety of ways. The details regarding the calculation and the application of the assessment structure 224 will be discussed below.

It has been discovered the present invention provides the resource management system 100 with improved cost efficiency. The assessment structure 224 directly related to the cost gives rise to the improved cost efficiency by directly and dynamically reflecting the actual cost of providing the resource in the price rather than a flat or predetermined pricing scheme. Market theory can apply to maximize cost efficiency based on the direct relationship between the price and the cost.

The supplier display interface 202 can also show an incentive 226 and a behavioral stimulus 228. The incentive 226 is defined as discounts or price breaks, such as 10% off of the monthly bill or one time $100 deduction, for meeting certain conditions. For example, the incentive 226 can be price breaks given for agreeing to allow the resource management system 100 to control the thermostat settings, when the particular client structure is a smart home, when the consumer installs batteries or solar panels, upgrading the first device 110, or any combination thereof.

The behavioral stimulus 228 is defined as a benefit, such as a discount in price or a gift, given to the consumer for agreeing to a specific action, for changing specific behavior patterns. The resource management system 100 can use the behavioral stimulus 228 to influence the demand for the resource 103 and optimize the production and usage of the resource 103. The resource management system 100 can use the behavioral stimulus 228 for the client structures 102 having a sensor network system, a gateway, or both connected to the first device 110 or as part of the first device 110.

For example, the behavioral stimulus 228 can be a reduction in price if the consumer opens the fridge door for less than 10 seconds each time, less than a specified number of times in a day, or both. Also, for example, the behavioral stimulus 228 can be a gift sent to the consumer if they reduce the television operation time by 20%.

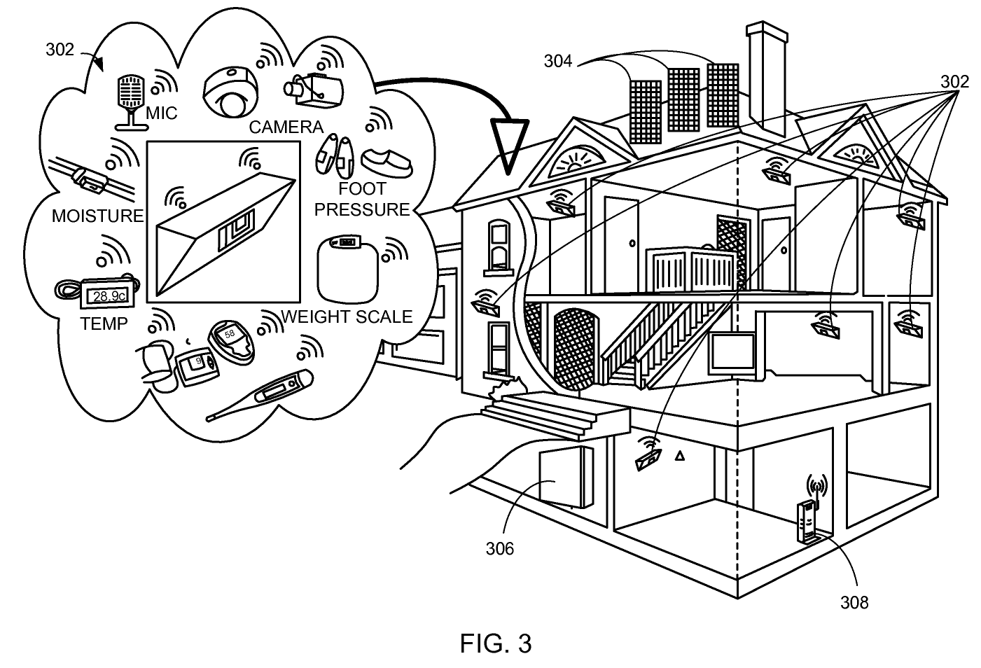

Referring now to FIG. 3, therein is shown an example of one of the client structures 102 of FIG. 1. The client structures 102 can have a sensor network 302, a solar panel 304, a battery bank 306, and a gateway 308. The sensor network 302, the solar panel 304, and the battery bank 306 can all be connected to the gateway 308. The gateway can be connected to the resource distribution network 106 of FIG. 1, the communication network 108 of FIG. 1, or both.

The sensor network 302 is defined as a series of sensors, such as a camera or a heart rate monitor that can communicate with the gateway 308, between the sensors, or both. The sensor network 302 can have the sensors and the gateway 308 connected through wires or wireless communication methods.

The sensor network 302 can detect, determine, observe, or a combination thereof the behavior of the consumers and the usage pattern of the resource 103 of FIG. 1 within the client structures 102 of FIG. 1. The sensor network 302 can send the detected, determined, or observed information to the gateway 308, which can relay the information to the first device 110 of FIG. 1 and the second device 112 of FIG. 1.

The solar panel 304 is defined as a packaged assembly of photovoltaic cells that convert light energy into electricity. The solar panel 304 can supply electricity to the client structures 102.

The battery bank 306 is defined as a reservoir for holding the resource 103 for use at a later time. For example, the battery bank 306 can be an electrical battery or a tank for holding gasoline or natural gas. The contents of the battery bank 306 can be used when the price for the resource 103 is high and can be recharged when the price is low.

The gateway 308 is defined as a device for controlling the various devices, systems and appliances in the client structures 102 and for gathering the behavioral and usage data. The gateway 308 can be a server or a computer that communicates with the sensor network 302, the solar panel 304, the battery bank 306, heating or cooling system, lights, outlets, valves, appliances, devices, or a combination thereof. The gateway 308 can gather the information from all of the connections and send it to the first device 110, the second device 112, or both.

The gateway 308 can also have a control mechanism for controlling all of the connections. For example, the gateway 308 can have a circuit for setting the thermostat or a signal for turning each individual light switch on or off.

The first device 110 can be configured in many ways within the client structures 102. For example, the first device 110 can include the sensor network 302, the solar panel 304, the battery bank 306, the gateway 308, or any combination thereof. Also, for example, the first device 110 can also be connected to and have control over the sensor network 302, the solar panel 304, the battery bank 306, the gateway 308, or a combination thereof. Yet for further example, the first device 110 can be the gateway 308.

The first device 110 can also be connected to different controllers. For example, the first device 110 can be connected to and have control over the various appliances, such as refrigerator or the television, sources for the resource 103 of FIG. 1, such as the water faucet or the electrical outlets, locking mechanisms, central temperature regulator, or any combination thereof.

The resource management system 100 can gather data regarding the consumption of the resource 103 within the client structures 102 using the first device 110, through the sensor network 302 and the gateway 308. The resource management system 100 can also control the consumption of the resource 103 within the client structures 102 using the first device 110, through the connections to the various controllers mentioned above.

It has been discovered that the present invention provides the resource management system 100 with improved conservation of the resource 103 and the cost for the client structures 102. The combination of the first device 110, the sensor network 302 and the gateway 308 gives rise to the improved conservation of the resource 103 and lower cost to the consumer by providing detailed information regarding the consumer usage and behavior for creating an accurate conservation method by the resource management system 100 and directly controlling the consumption to follow the conservation method.

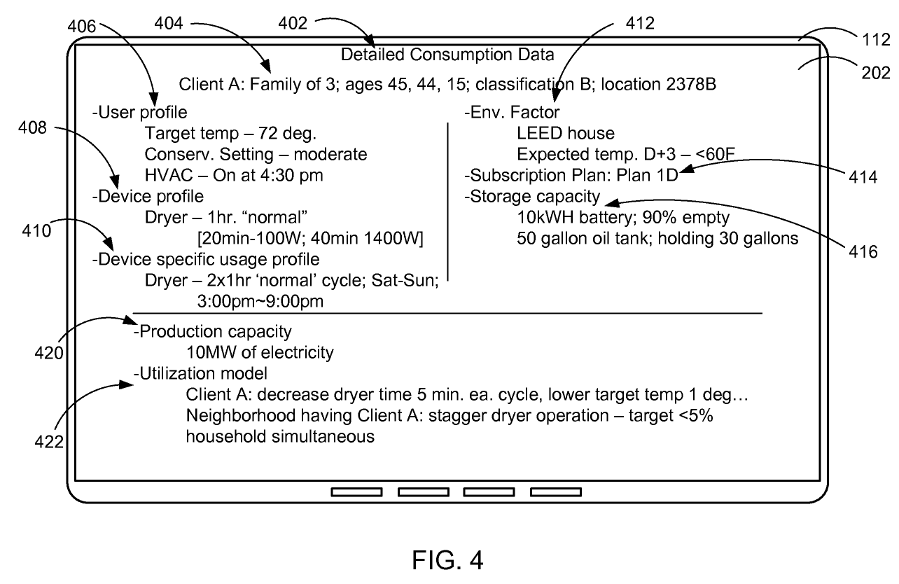

Referring now to FIG. 4, therein is shown a further example of the supplier display interface 202 on the second device 112. The supplier display interface 202 can show a detailed consumption data 402 of one of the client structures 102 of FIG. 1.

The detailed consumption data 402 is defined as a set of information regarding the usage of the resource 103 of FIG. 1 in one instance of the client structures 102. One instance of the detailed consumption data 402 can exist for each of the client structures 102. The resource management system 100 of FIG. 1 can receive, determine, or calculate various data making up the detailed consumption data 402.

For example, the resource management system 100 can determine the usage amount of the resource 103 overall for a house or for individual appliances and systems within a house. The resource management system 100 can receive updated models, forecasts, environmental concerns, or other information that can be used to predict future usage and control production. The resource management system 100 can calculate the data components making up the detailed consumption data 402.

The resource management system 100 can determine the detailed consumption data 402 using user or client volunteered information, publically available information, or a combination thereof. The resource management system 100 can determine the detailed consumption data 402 from the client information required for services regarding the resource 103. For example, the resource management system 100 can use the information required for signing up to receive water or internet service.

The resource management system 100 can further interact with the client to receive any volunteered information. For example, the resource management system 100 can use computer interfaces, such as a webpage or a smart phone application, or mail correspondences to ask the client to provide, if willing, other information for the detailed consumption data 402.

The resource management system 100 can also access publically available information to determine the detailed consumption data 402. For example, the resource management system 100 can access census data, government registry or databases, survey information, privately owned and publically available databases or webpages, or a combination thereof. The details regarding the determination of the detailed consumption data 402 will be discussed below.

The detailed consumption data 402 can include a user background 404, a user profile 406, a device profile 408, a device-specific usage profile 410, an environmental factor 412, a subscription plan 414, and a storage capacity 416. The user background 404 is defined as demographical information regarding the instance of the client structures 102.

The user background 404 can include information regarding the occupants residing in or is a member the instance of the client structures 102. The user background 404 can include personal information or socio-economic data of the occupants, number of members or occupants, individual profiles or schedules of the members, organizational classification, organizational structure, or a combination thereof.

For example, the user background 404 can include organizational classification that a particular client structure is a family home for a family of 3. The organizational structure can include that the family consists of a father, a mother, and a son, and further include in individual profiles that the ages of the family members are 45, 44, and 15. The user background 404 can also have a determined classification based on the socio-economic data or the socio-economic data itself, such as income level or field of work, as volunteered by the clients or that is publicly available.

The user profile 406 is defined as client provided settings for operating systems or devices that consume the resource 103. The user profile 406 can be the settings for the devices or systems that consume the resource 103. The user profile 406 can have settings that include magnitude, schedule or duration, priority, purpose, order, or a combination thereof regarding devices using the resource 103.

The user profile 406 can be for the overall usage of the resource 103 of a corresponding client structure or for individual members of the corresponding client structure. The detailed consumption data 402 can have multiple instances of the user profile 406 to account for the individual members of the corresponding client structure. . . .

For example, the user profile 406 can include temperature settings related to seasons or outside temperatures, or light settings for different times of the day and the day of the week. Also, for example, the user profile 406 can include television or video game settings, such as in allowed access times, for each child in the house.

The device profile 408 is defined as consumption profile for a device or a system within the corresponding client structure that consumes the resource 103. The device profile 408 can be the amount of the resource 103 that the device or the system consumes at various settings, output magnitudes, operating duration, in relation to environmental factors, such as ambient temperature or device state, or a combination thereof.

For example, the device profile 408 for the electricity consumption of a particular model of dryer operating at normal cycle can be total of 1500 watt for one hour. The dryer can consume 100 watts having only the drums rotate for the first 20 minutes. The dryer can additionally use the heating element for the next 40 minutes to consume 1400 watts.

Also, for example, the device profile 408 can be for the gas consumption of the central heating system based on the system specification, past usage records, or a combination thereof. The device profile 408 can have the amount of gas or electricity required to achieve various desired indoor temperatures based on different outside temperatures, starting indoor temperature, total number and location of occupants, or a combination thereof. The device profile 408 can also have the amount of gas or electricity required to maintain the desired indoor temperature.

The resource management system 100 can receive the device profile 408 from the device or system manufacturer. For example, the resource management system 100 can use the sensor network 302 of FIG. 3 to identify different devices or systems within the corresponding instance of the client structures 102. The resource management system 100 can use the sensor network 302 to communicate with the device or system through wired or wireless communication to identify the device or system. The resource management system 100 can use the communication network 108 of FIG. 1 to communicate with the manufacturer of the device or system to receive the consumption profile.

The resource management system can also determine the device profile 408 from the device or system provided usage rating or from past consumption records. For example, the resource management system 100 can use the sensor network 302 to receive the consumption rating or consumption profile from individual devices or systems.

Also, for example, the resource management system 100 can use the sensor network 302 to identify the settings of the devices or systems that are operating. The resource management system 100 can record the settings of the devices with the total consumption amount for the corresponding client structure. The resource management system 100 can use the recorded past values to calculate the consumption information for various devices.

The device-specific usage profile 410 is defined as a usage profile specific to a device or a system. The device-specific usage profile 410 can be a pattern of usage for the corresponding device or system. For example, the device-specific usage profile 410 can be the times of day when a set of lights have previously consumed the resource 103. Also, for example, the device-specific usage profile 410 can be the times of the year that the central heater or cooling system has operated and the settings corresponding to each previous usage.

The device-specific usage profile 410 can also be a calculated or projected usage pattern of the device or system. The resource management system 100 can use past usage, average usage patterns found throughout the resource management system 100, information from manufacturer, publically available usage information for the corresponding device or system to calculate the likely future usage pattern of the device or system.

For example, the device-specific usage profile 410 can calculate the future usage pattern of the dryer to be two one-hour normal cycles on Sunday between 3:00 pm and 6:00 pm based on past usage patterns. Also, for example, the device-specific usage profile 410 can forecast that the heater will likely operate in the evening in three days when the outside temperature is predicted to go below 60 degrees.

The environmental factor 412 is defined as factors external to or regarding the client structures 102 that affect the consumption of the resource 103. The environmental factor 412 can be external factors, such as the weather or drought warnings. The environmental factor 412 can also be factors relating to the corresponding instance of the client structures 102.

For example, structures built according to leadership in energy and environmental design (LEED). Also, for example, the environmental factor 412 can be related to the heat retention or isolation quality of the particular structure.

The subscription plan 414 is defined as a pricing structure related to consuming the resource 103, receiving related services, or both. For example, the subscription plan 414 can be a tier based model using tiers of consumption amount, flat rate based model, a fixed price model for unlimited usage, or a combination thereof.

The storage capacity 416 is defined as the amount of storage available at the corresponding client structure for storing the resource 103. The storage capacity 416 can be maximum possible storage amount, such as the size of the oil or gasoline tank, electrical capacity of the battery, or a combination thereof. The storage capacity 416 can also be the total available amount of storage. For example, the storage capacity 416 can be the difference between the maximum possible storage amount and the current storage amount.

The supplier display interface 202 can also show a production capacity 420, and a utilization model 422. The production capacity 420 is defined as the maximum production capacity of the resource 103 for the resource supplier 104 of FIG. 1. The production capacity 420 can be the maximum capacity of the generator that the resource supplier 104 can use. The production capacity 420 can be the maximum capacity or the total tank size, raw material supply rate, processing rate, or a combination thereof for a gas or oil supplier.

The production capacity 420 can further depend on environmental factors. For example, the production capacity of 420 can depend on the water level of a reservoir or the season of the year at a hydro-power plant. Also, for example, the production capacity 420 of a refinery can depend on the status of the oil wells supplying the refinery.

The utilization model 422 is defined as determined methods for optimizing the consumption of the resource 103 in one instance or a grouping of the client structures 102. The utilization model 422 can be a set of acts or methods for optimizing the consumption and production of the resource 103 as applicable to each of the client structures 102 or the individual members therein.

The resource management system 100 can calculate the utilization model 422 using models, such as mathematical models or according to methods as predetermined by the resource management system 100, the hardware or software manufacturer, or a combination thereof. The utilization model 422 can be determined using the detailed consumption data 402, data from the sensor network 302, the client-usage forecast 206, the total usage forecast 210, the production capacity 420, individual or socio-economic behavioral data, seasonal behavioral data, surveys, or a combination thereof.

The utilization model 422 can be designed to optimize the consumption of the resource 103 for various targets. For example, the utilization model 422 can be methods for optimizing the consumption of the resource 103 in view of the production for each of the client structures 102, certain groupings of the client structures 102, the resource supplier 104, or a combination thereof.

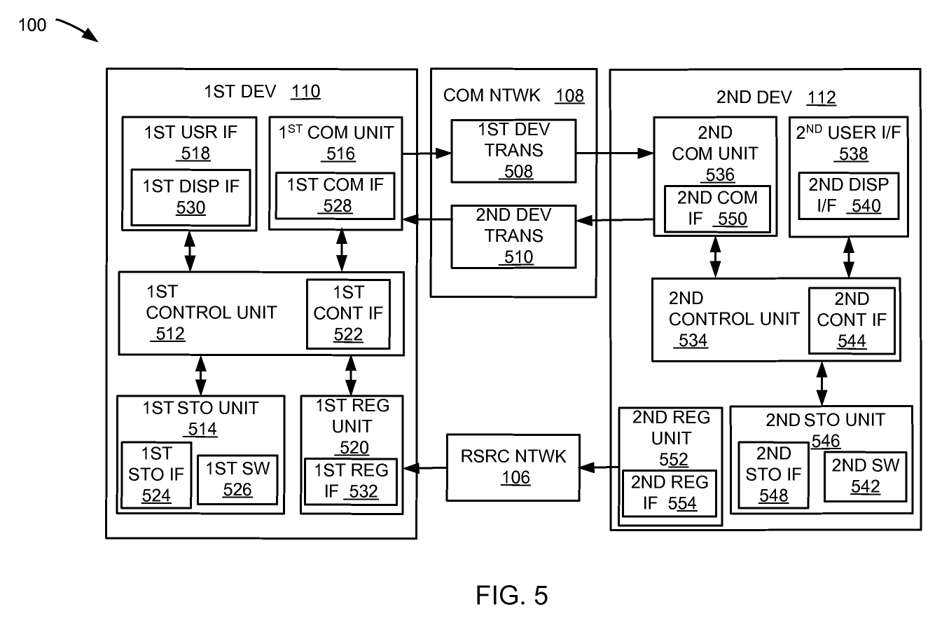

Referring now to FIG. 5, therein is shown an exemplary block diagram of the resource management system 100. The resource management system 100 can include the first device 110, the second device 112, the resource distribution network 106, and the communication network 108. The first device 110 can communicate with anything within the communication network 108, including the second device 112.

For illustrative purposes, the resource management system 100 will be described as having the first device 110 interacting with the second device 112 through the communication network 108. It is understood that the first device 110 can communicate with other instances of the first device 110 in other instances of the client structures 102 of FIG. 1 or other information sources, such as a server or telephones through the communication network 108.

For example, the first device 110 can communicate with other identical or similar devices located in other residences or businesses. Also, for example, the first device 110 can send and receive information from servers and computers through the internet.

The first device 110 can send information in a first device transmission 508 over the communication network 108 to the second device 112. The second device 112 can send information in a second device transmission 510 over the communication network 108 to the first device 110.

For illustrative purposes, the resource management system 100 is shown with the first device 110 as a client device, although it is understood that the resource management system 100 can have the first device 110 as a different type of device. For example, the first device 110 can be a server.

Also for illustrative purposes, the resource management system 100 is shown with the second device 112 as a server, although it is understood that the resource management system 100 can have the second device 112 as a different type of device. For example, the second device 112 can be a client device.

For brevity of description in this embodiment of the present invention, the first device 110 will be described as a client device located in consumer entities and the second device 112 will be described as a server and controller located in the provider entities. The present invention is not limited to this selection for the type of devices. The selection is an example of the present invention.

The first device 110 can include a first control unit 512, a first storage unit 514, a first communication unit 516, a first user interface 518, and a first regulator unit 520. The first device 110 can be similarly described by the first device 110. The first control unit 512 can include a first control interface 522. The first storage unit 514 can include a first storage interface 524.

The first control unit 512 can execute a first software 526 to provide the intelligence of the resource management system 100. The first control unit 512 can operate the first user interface 518 to display information generated by the resource management system 100. The first control unit 512 can also execute the first software 526 for the other functions of the resource management system 100, including receiving location information from the first regulator unit 520. The first control unit 512 can further execute the first software 526 for interaction with the communication network 108 of FIG. 1 via the first communication unit 516.

The first control unit 512 can be implemented in a number of different manners. For example, the first control unit 512 can be a processor, an embedded processor, a microprocessor, a hardware control logic, a hardware finite state machine, a digital signal processor, or a combination thereof.

The first control unit 512 can include the first control interface 522. The first control interface 522 can be used for communication between the first control unit 512 and other functional units in the first device 110. The first control interface 522 can also be used for communication that is external to the first device 110.

The first control interface 522 can receive information from the other functional units or from external sources, or can transmit information to the other functional units or to external destinations. The external sources and the external destinations refer to sources and destinations external to the first device 110.

The first control interface 522 can be implemented in different ways and can include different implementations depending on which functional units or external units are being interfaced with the first control interface 522. For example, the first control interface 522 can be implemented with a pressure sensor, an inertial sensor, a microelectromechanical system, optical circuitry, waveguides, wireless circuitry, wired circuitry, or a combination thereof.

The first storage unit 514 can store the first software 526. The first storage unit 514 can also store the relevant information, such as phone numbers, identification information, user profiles, predetermined goals, resource cost forecasts, user inputs and configurations, or any combination thereof.

The first storage unit 514 can be a volatile memory, a nonvolatile memory, an internal memory, an external memory, or a combination thereof. For example, the first storage unit 514 can be a nonvolatile storage such as non-volatile random access memory, Flash memory, disk storage, or a volatile storage such as static random access memory.

The first storage unit 514 can include the first storage interface 524. The first storage interface 524 can be used for communication between the first regulator unit 520 and other functional units in the first device 110. The first storage interface 524 can also be used for communication that is external to the first device 110.

The first storage interface 524 can receive information from the other functional units or from external sources, or can transmit information to the other functional units or to external destinations. The external sources and the external destinations refer to sources and destinations external to the first device 110.

The first storage interface 524 can include different implementations depending on which functional units or external units are being interfaced with the first storage unit 514. The first storage interface 524 can be implemented with technologies and techniques similar to the implementation of the first control interface 522.

The first communication unit 516 can enable external communication to and from the first device 110. For example, the first communication unit 516 can permit the first device 110 to communicate with the second device 112, an attachment, such as a peripheral device or a computer desktop.

The first communication unit 516 can also function as a communication hub allowing the first device 110 to function as part of the communication network 108 and not limited to be an end point or terminal unit to the communication network 108. The first communication unit 516 can include active and passive components, such as microelectronics or an antenna, for interaction with the communication network 108.

The first communication unit 516 can include a first communication interface 528. The first communication interface 528 can be used for communication between the first communication unit 516 and other functional units in the first device 110. The first communication interface 528 can receive information from the other functional units or can transmit information to the other functional units.

The first communication interface 528 can include different implementations depending on which functional units are being interfaced with the first communication unit 516. The first communication interface 528 can be implemented with technologies and techniques similar to the implementation of the first control interface 522.

The first user interface 518 allows a user to interface and interact with the first device 110. The first user interface 518 can include an input device and an output device. Examples of the input device of the first user interface 518 can include a keypad, a touchpad, soft-keys, a keyboard, a microphone, or any combination thereof to provide data and communication inputs.

The first user interface 518 can include a first display interface 530. Examples of the output device of the first user interface 518 can include the first display interface 530. The first display interface 530 can include a display, a projector, a video screen, a speaker, or any combination thereof.

The first regulator unit 520 can control other devices that use or control the resource 103 of FIG. 1, such as the water faucet or the lights, or store the resource 103, as examples. The first regulator unit 520 can be implemented in many ways. For example, the first regulator unit 520 can be a central switching unit that can connect or disconnect the power to the wall power outlets or a signal driver to control the light switches. Also, for example, the first regulator unit 520 can be a digital driver coupled to the solar panel 304 of FIG. 3 for controlling the allocation of the generated power.

The first regulator unit 520 can also be connected to the resource distribution network 106. For example, the first regulator unit 520 can be connected to the gas line coming into the house, the electrical wires at different points within the factory, gas tanks, or a combination thereof. The first regulator unit 520 can control the amount of the resource 103 transferring between each of the client structures 102 and the resource supplier 104 of FIG. 1 at the client structures 102 and the usage of the resource 103 within the client structures 102.

The first regulator unit 520 can include a first regulator interface 532. The first regulator interface 532 can be used for communication between the first regulator unit 520 and other functional units in the first device 110. The first regulator interface 532 can also be used for communication that is external to the first device 110.

The first regulator interface 532 can receive information from the other functional units or from external sources, or can transmit information to the other functional units or to external destinations. The external sources and the external destinations refer to sources and destinations external to the first device 110.

The first regulator interface 532 can include different implementations depending on which functional units or external units are being interfaced with the first regulator unit 520. The first regulator interface 532 can be implemented with technologies and techniques similar to the implementation of the first control unit 512.

For illustrative purposes, the first device 110 is shown with the partition having the first control unit 512, the first storage unit 514, the first user interface 518, the first communication unit 516, and the first regulator unit 520 although it is understood that the resource management system 100 can have a different partition. For example, the first software 526 can be partitioned differently such that some or all of its function can be in the first control unit 512, the first regulator unit 520, and the first communication unit 516. Also, the first device 110 can include other functional units not shown in FIG. 5 for clarity.

The functional units in the first device 110 can work individually and independently of the other functional units. The first device 110 can work individually and independently from the second device 112 and the communication network 108.

The second device 112 can be optimized for implementing the present invention in a multiple device embodiment with the first device 110. The second device 112 can provide the additional or higher performance processing power compared to the first device 110. The second device 112 can include a second control unit 534, a second communication unit 536, and a second user interface 538.

The second user interface 538 allows a user to interface and interact with the second device 112. The second user interface 538 can include an input device and an output device. Examples of the input device of the second user interface 538 can include a keypad, a touchpad, soft-keys, a keyboard, a microphone, or any combination thereof to provide data and communication inputs. Examples of the output device of the second user interface 538 can include a second display interface 540. The second display interface 540 can include a display, a projector, a video screen, a speaker, or any combination thereof.

The second control unit 534 can execute a second software 542 to provide the intelligence of the second device 112 of the resource management system 100. The second software 542 can operate in conjunction with the first software 526. The second control unit 534 can provide additional performance compared to the first control unit 512.

The second control unit 534 can operate the second user interface 538 to display information. The second control unit 534 can also execute the second software 542 for the other functions of the resource management system 100, including operating the second communication unit 536 to communicate with the first device 110 over the communication network 108.

The second control unit 534 can be implemented in a number of different manners. For example, the second control unit 534 can be a processor, an embedded processor, a microprocessor, a hardware control logic, a hardware finite state machine, a digital signal processor, or a combination thereof.

The second control unit 534 can include a second controller interface 544. The second controller interface 544 can be used for communication between the second control unit 534 and other functional units in the second device 112. The second controller interface 544 can also be used for communication that is external to the second device 112.

The second controller interface 544 can receive information from the other functional units or from external sources, or can transmit information to the other functional units or to external destinations. The external sources and the external destinations refer to sources and destinations external to the second device 112.

The second controller interface 544 can be implemented in different ways and can include different implementations depending on which functional units or external units are being interfaced with the second controller interface 544. For example, the second controller interface 544 can be implemented with a pressure sensor, an inertial sensor, a micro electromechanical system, optical circuitry, waveguides, wireless circuitry, wireline circuitry, or a combination thereof.

A second storage unit 546 can store the second software 542. The second storage unit 546 can also store the relevant information, such as phone numbers, identification information, user profiles, predetermined goals, resource cost forecasts, user inputs and configurations, or any combination thereof. The second storage unit 546 can be sized to provide the additional storage capacity to supplement the first storage unit 514.

For illustrative purposes, the second storage unit 546 is shown as a single element, although it is understood that the second storage unit 546 can be a distribution of storage elements. Also for illustrative purposes, the resource management system 100 is shown with the second storage unit 546 as a single hierarchy storage system, although it is understood that the resource management system 100 can have the second storage unit 546 in a different configuration. For example, the second storage unit 546 can be formed with different storage technologies forming a memory hierarchal system including different levels of caching, main memory, rotating media, or off-line storage.

The second storage unit 546 can be a volatile memory, a nonvolatile memory, an internal memory, an external memory, or a combination thereof. For example, the second storage unit 546 can be a nonvolatile storage such as non-volatile random access memory, Flash memory, disk storage, or a volatile storage such as static random access memory.

The second storage unit 546 can include a second storage interface 548. The second storage interface 548 can be used for communication between the first regulator unit 520 and other functional units in the second device 112. The second storage interface 548 can also be used for communication that is external to the second device 112.

The second storage interface 548 can receive information from the other functional units or from external sources, or can transmit information to the other functional units or to external destinations. The external sources and the external destinations refer to sources and destinations external to the second device 112.

The second storage interface 548 can include different implementations depending on which functional units or external units are being interfaced with the second storage unit 546. The second storage interface 548 can be implemented with technologies and techniques similar to the implementation of the second controller interface 544.

The second communication unit 536 can enable external communication to and from the second device 112. For example, the second communication unit 536 can permit the second device 112 to communicate with the first device 110 over the communication network 108.

The second communication unit 536 can also function as a communication hub allowing the second device 112 to function as part of the communication network 108 and not limited to be an end point or terminal unit to the communication network 108. The second communication unit 536 can include active and passive components, such as microelectronics or an antenna, for interaction with the communication network 108.

The second communication unit 536 can include a second communication interface 550. The second communication interface 550 can be used for communication between the second communication unit 536 and other functional units in the second device 112. The second communication interface 550 can receive information from the other functional units or can transmit information to the other functional units.

The second communication interface 550 can include different implementations depending on which functional units are being interfaced with the second communication unit 536. The second communication interface 550 can be implemented with technologies and techniques similar to the implementation of the second controller interface 544.

The first communication unit 516 can couple with the communication network 108 to send information to the second device 112 in the first device transmission 508. The second device 112 can receive information in the second communication unit 536 from the first device transmission 508 of the communication network 108.

The second communication unit 536 can couple with the communication network 108 to send information to the first device 110 in the second device transmission 510. The first device 110 can receive information in the first communication unit 516 from the second device transmission 510 of the communication network 108. The resource management system 100 can be executed by the first control unit 512, the second control unit 534, or a combination thereof.

The second device 112 can have a second regulator unit 552. The second regulator unit 552 can control other devices that use or control the resource 103, such as the water faucet or the lights, or store the resource 103, as examples. The second regulator unit 552 can be implemented in many ways. For example, the second regulator unit 552 can be a central switching unit that can connect or disconnect the power to the wall power outlets or a signal driver to control the light switches. Also, for example, the second regulator unit 552 can be a digital driver coupled to the solar panel 304 for controlling the allocation of the generated power.

The second regulator unit 552 can also be connected to the resource distribution network 106. For example, the second regulator unit 552 can be connected to the gas line coming into the house, the electrical wires at different points within the factory, gas tanks, or a combination thereof. The second regulator unit 552 can control the amount of the resource 103 transferring between each of the client structures 102 and the resource supplier 104 at the resource supplier 104.

The second regulator unit 552 can include a second regulator interface 554. The second regulator interface 554 can be used for communication between the second regulator unit 552 and other functional units in the second device 112. The second regulator interface 554 can also be used for communication that is external to the second device 112.

The second regulator interface 554 can receive information from the other functional units or from external sources, or can transmit information to the other functional units or to external destinations. The external sources and the external destinations refer to sources and destinations external to the second device 112.

The second regulator interface 554 can include different implementations depending on which functional units or external units are being interfaced with the second regulator unit 552. The second regulator interface 554 can be implemented with technologies and techniques similar to the implementation of the first control unit 512.

For illustrative purposes, the second device 112 is shown with the partition having the second user interface 538, the second storage unit 546, the second control unit 534, and the second communication unit 536, although it is understood that the second device 112 can have a different partition. For example, the second software 542 can be partitioned differently such that some or all of its function can be in the second control unit 534 and the second communication unit 536. Also, the second device 112 can include other functional units not shown in FIG. 5 for clarity.

The functional units in the second device 112 can work individually and independently of the other functional units. The second device 112 can work individually and independently from the first device 110 and the communication network 108.

For illustrative purposes, the resource management system 100 is described by operation of the first device 110 and the second device 112. It is understood that the first device 110 and the second device 112 can operate any of the modules and functions of the resource management system 100. For example, the first device 110 is described to operate the first regulator unit 520, although it is understood that the second device 112 can also operate the first regulator unit 520.

For further illustrative purposes, the resource management system 100 is described as having the first device 110 interacting with the second device 112 through the communication network 108. It is understood that the first device 110, having identical or similar components as the second device 112 can interact with the first device 110.

For example, the first device 110 can have the second communication unit 536 therein to communicate with the second device 112. Also, for example, the first device 110 can have the second control unit 534, the second storage unit 546, and the second user interface 538 for carrying on the same functions as the second device 112.

It has been discovered that the present invention provides the resource management system 100 with improved conservation of the resource 103. The combination of the assessment structure 224 of FIG. 2, the forecasts 206 of FIGS. 2 and 208 of FIG. 2, the optimization models 218 of FIGS. 2 and 220 of FIG. 2, the first device 110 having control over the resource supplier 104, and the second device 112 having control over the client structures 102 gives rise to the improved conservation by directly controlling the production and usage to mimic the optimization models 218 and 220.

The first device 110 can use the first user interface 518, the first regulator unit 520, the first control unit 512, or a combination thereof to control the consumption of the resource 103 to closely follow the client-optimization model 218. The second device 112 can use the second user interface 538, the second regulator unit 552, the second control unit 534, or a combination thereof to control the production of the resource 103 at the resource supplier 104 to closely follow the total-optimization model 220.

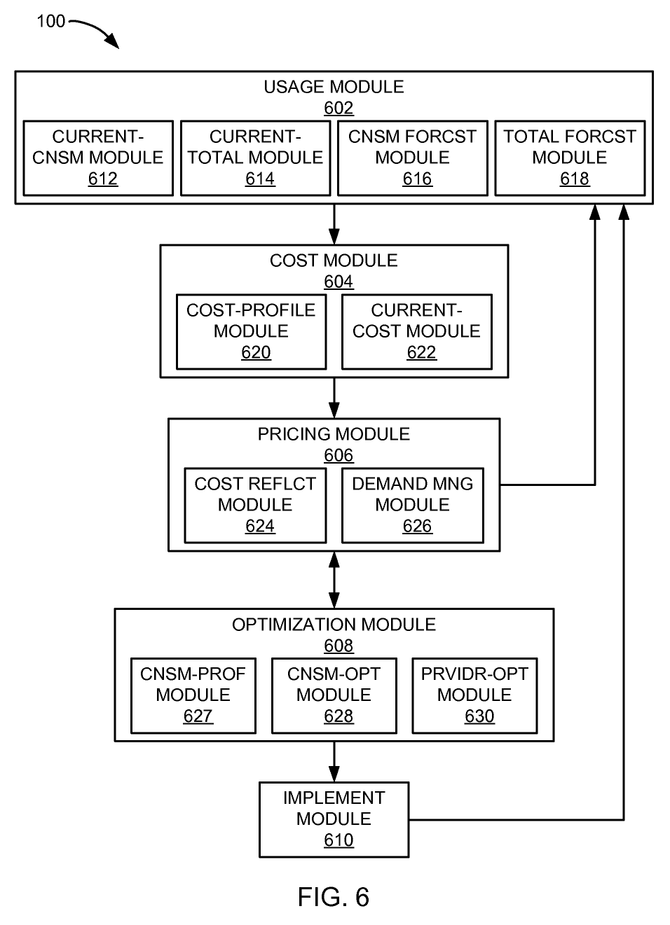

Referring now to FIG. 6, therein is shown a control flow of the resource management system 100. The resource management system 100 can have a usage module 602, a cost module 604, a pricing module 606, an optimization module 608, and an implementation module 610.

The usage module 602 can be coupled to the cost module 604, which can be coupled to the pricing module. The pricing module 606 can be coupled to the optimization module 608 and the usage module 602. The optimization module can be coupled to the implementation module 610. The implementation module 610 can also be coupled to the usage module 602.

The usage module 602 is for identifying the usage amount of the resource 103 of FIG. 1 and forecasting the future usage amounts. The usage module 602 can identify the usage amount by identifying the client-usage status 204 of FIG. 2, the total-usage status 208 of FIG. 2, or both. The usage module 602 can forecast the future usage amounts by determining the client-usage forecast 206 of FIG. 2, the total-usage forecast 210 of FIG. 2, or both.

The usage module 602 can have a current-consumer module 612, a current-total module 614, a consumer forecast module 616, and a total forecast module 618. The current-consumer module 612 is for identifying the client-usage status 204 of the resource 103 at each of the client structures 102 of FIG. 1.

The current-consumer module 612 can identify the client-usage status 204 by measuring the amount of usage. The current-consumer module 612 can be coupled to the devices that measure the amount of the resource 103 entering or being used in the client structures 102, such as the electric meter or the gas tank meter. The current-consumer module 612 can receive readings and feedbacks regarding the amount of use from the measuring devices at the client structures 102.

The current-consumer module 612 can send a request to the first communication unit 516 of FIG. 5 on the first device 110 of FIG. 1 over the communication network 108 of FIG. 1. The first device 110 can use the first control unit 512 of FIG. 5 to read the measurement from a measurement device coupled to the first device 110. The first device 110 can also have measurement capability through the first user interface 518 of FIG. 5 or on the first regulator unit 520 of FIG. 5.

The current-consumer module 612 can also identify the client-usage status 204 of the resource 103 currently consumed in each of the client structures 102 using the sensor network 302 of FIG. 3 located at each of the client structures 102. The current-consumer module 612 can receive the data from the sensor network 302 to determine what devices or systems are consuming the resource 103 within the client structures 102 and the amount of consumption for each device or system. The current-consumer module 612 can sum the amounts with each of the client structures 102 to identify the client-usage status 204.

The first device 110 can send the measurement information to the second device 112 of FIG. 1 through the communication network 108, store the usage information in the first storage unit 514 of FIG. 5, or both. The second device 112 can use the second control unit 534 of FIG. 5 to process the usage information, the second storage unit 546 of FIG. 5 to store the usage information, or both.

The current-consumer module 612 can receive readings and feedbacks regarding the amount of use, thereby identify the client-usage status 204, by having the first control unit 512, the second control unit 534, or both processing the measurement readings. The current-consumer module 612 can also identify the client-usage status 204 by storing the measurement readings in the first storage unit 514, the second storage unit 546, or both.

The current-total module 614 is for identifying the total-usage status 208 of the resource 103 currently supplied by the resource supplier 104 of FIG. 1 to the client structures 102. The current-total module 614 can identify the total-usage status 208 by summing all of the client-usage status 204 of the client structures 102.

The current-total module 614 can use the first control unit 512, the second control unit 534, or both to add all of the client-usage status 204 when they are received to identify the total-usage status 208. The current-total module 614 can also use the first control unit 512, the second control unit 534, or both to access the client-usage status 204 stored in the first storage unit 514, the second storage unit 546, or both, and then add the client-usage status 204 together to identify the total-usage status 208.

The current-total module 614 can also identify the total-usage status 208 by measuring the total output of the resource 103 at the resource supplier 104. The current-total module 614 can use the second control unit 534 to read the measurement from a measurement device coupled to the second device 112. The second device 112 can also have measurement capability through the second user interface 538 of FIG. 5 or on the second regulator unit 552 of FIG. 5.

The current-total module 614 can also identify the total-usage status 208 by both measuring and summing methods. The current-total module 614 can use the output from two separate methods for verification, calibration, troubleshooting, self-diagnosis or evaluation, or any combination of purposes or processes thereof.

The consumer forecast module 616 is for determining the client-usage forecast 206. The consumer forecast module 616 can determine the client-usage forecast 206 by determining the forecast model 214 of FIG. 2. The consumer forecast module 616 can also use the sensor network 302.

The consumer forecast module 616 can determine the forecast model 214 by comparing the outputs of the various models to the client-usage status 204. The consumer forecast module 616 can determine the forecast model 214 by selecting and using the method that is closest to the client-usage status 204. The consumer forecast module 616 can similarly select and use the method that is the closest to the client-usage status 204 over a period of time.

The consumer forecast module 616 can also determine the forecast model 214 following predetermined methods or steps. For example, the consumer forecast module 616 can use the specific methods during certain periods of the year, for certain types of consumers, for certain patterns of usage, for certain usage levels, or any combination thereof.

The consumer forecast module 616 can determine the client-usage forecast 206 by using the forecast model 214 and the past records of the client-usage forecast 206. The consumer forecast module 616 can also determine the client-usage forecast 206 using the client-usage status 204, the detailed consumption data 402 of FIG. 4 for each of the client structures 102 as determined and adjust by the optimization module 608, the cost profile 222 of FIG. 2, the client-optimization model 218 of FIG. 2, level or result of the implementation of the client-optimization model 218, data from the sensor network 302, or any combination thereof.

The consumer forecast module 616 can receive detailed information regarding the behaviors and patterns tied to the usage of the resource 103 using the sensor network 302. For example, the consumer forecast module 616 can receive the number of times a refrigerator door is opened during a time period and the duration the door stays open each time. Also, for example, the consumer forecast module 616 can differentiate between an unoccupied structure and when occupants are sleeping.

The level of details available for the present invention provides the resource management system 100 with improved accuracy in the forecasts. The combination of the sensor network 302 and the consumer forecast module 616 and production module give rise to the improved accuracy by allowing the consumer forecast module 616 to account for individual behaviors causing the usage pattern, not just simple consumption amount, in calculating the client-usage forecast 206.

The consumer forecast module 616 can use the first control unit 512, the second control unit 534, or both to determine the forecast model 214 and to process the information according the forecast model 214. The consumer forecast module 616 can access the various models and the necessary information stored in the first storage unit 514, the second storage unit 546, or both. The consumer forecast module 616 can store the forecast model 214, the client-usage forecast 206, or both in the first storage unit 514, the second storage unit 546, or both.

The total forecast module 618 is for determining the total-usage forecast 210. The total forecast module 618 can determine the total-usage forecast 210 by adding all of the client-usage forecast 206 for the client structures 102. The total forecast module 618 can also determine the total-usage forecast 210 by determining the forecast model 214 and processing the information according to the forecast model 214 using similar methods as the consumer forecast module 616.

The total forecast module 618 can also identify the total-usage status by both forecasting and summing methods. The total forecast module 618 can use the output from two methods for verification, calibration, troubleshooting, self-diagnosis or evaluation, or any combination of purposes or processes thereof. The total forecast module 618 can also use the output from the two methods for selecting the forecast model 214.

The various results regarding usage can be passed to the cost module 604 for cost evaluation. The cost module 604 is for identifying the cost for producing the resource 103. The cost module 604 can identify the current cost by determining the current production amount 216 of FIG. 2. The cost module 604 can also calculate the cost for producing various amounts of the resource 103 at various times and circumstances by calculating the cost profile 222.

In identifying the cost, the cost module 604 can determine the production capacity 420 of FIG. 4. The cost module 604 can determine the production capacity 420 by querying the generator, refinery, well, or a combination thereof. The cost module 604 can also determine the production capacity 420 by accessing the maximum production amount or rate as predetermined by the resource management system 100, the service provider, the hardware manufacturer, the builder, or a combination thereof.

The cost module 604 can sum the different rates or output amounts of each source, such as a generator or a tank size, to determine the production capacity 420. The cost module 604 can further determine the production capacity 420 by calculating the difference between the maximum amount or production rate and the existing amount of the resource 103 on reserve at the resource supplier 104.

The cost module 604 can have a cost-profile module 620 and a current-cost module 622. The cost-profile module 620 is for calculating the cost for producing various amounts of the resource 103 at various times and circumstances. The cost-profile module 620 can calculate the production cost by calculating the cost profile 222. The cost-profile module 620 can calculate the cost profile 222 relative to the production capacity 420.

The cost-profile module 620 can calculate the cost profile 222 by calculating the operational cost required to produce a desired output level of the resource 103. The cost-profile module 620 can calculate the number of employees necessary to operate the resource supplier 104 to the desired capacity and the sum of their salary.

The cost-profile module 620 can also calculate the amount of supplies, such as oil or electricity, necessary to operate the resource supplier 104 to the desired capacity. Further, the cost-profile module 620 can also determine if other sources within the resource supplier 104, such as back-up plants or additional generators, are required to produce the desired capacity, and the cost of operating such sources.

The cost-profile module 620 can convert the various costs into a common unit, such as British Thermal Units, kwh, or dollars. The cost-profile module 620 can use the communication network 108 to search for the conversion information necessary to convert the various costs into the common unit. The cost-profile module 620 can also use a conversion table preloaded within the first storage unit 514, the second storage unit 546, or both.

The cost-profile module 620 can acquire the various costs through using the first communication unit 516, the second communication unit 536 of FIG. 5, or both to acquire data over the communication network 108. For example, the cost-profile module 620 can access the payroll database and the shift schedule for the resource supplier 104 to find the labor cost. Also, for example, the cost-profile module 620 can acquire from the Internet the current cost of the oil, gasoline, or water necessary to supply the desired amount.

The cost-profile module 620 can also use predetermined values or equations for the various costs. The user, the software manufacturer, the resource supplier 104, or a combination thereof can predetermine the values.

The cost-profile module 620 can perform the cost evaluation for the above mentioned factors for supplying various levels of the resource 103. The cost-profile module 620 can sum the various supply costs for each level. The cost-profile module 620 can group the total sum of the cost for all of the output levels to calculate the cost profile 222.

The cost-profile module 620 can also characterize the individual cost behaviors as functions of the output level or the total cost as a function of the output level. The cost-profile module 620 can set the resulting function or equation as the cost profile 222. The cost-profile module 620 can calculate the cost profile 222 using the first control unit 512, the second control unit 534, or both and store the cost profile 222 in the first storage unit 514, the second storage unit 546, or both.

The current-cost module 622 is for determining the current cost of the resource supplier 104 for supplying the resource 103 to meet the current demand. The current-cost module 622 can determine the current cost of the resource supplier 104 by calculating the current production amount 216.

The current-cost module 622 can calculate the current production amount 216 by using the first control unit 512, the second control unit 534, or both to access the total-usage status 208 and the cost profile 222 stored in the first storage unit 514, the second storage unit 546, or both. The current-cost module 622 can find the cost corresponding to the total-usage status 208 according to the cost profile 222. The current-cost module can identify the current production amount 216 as the cost associated with the total-usage status 208 according to the cost profile 222.

The pricing module 606 is for setting the price for the resource 103 to directly reflect the cost of providing the resource 103 and also for managing the demand for the resource 103, such that the demand converges to the client-optimization model 218. The pricing module 606 can set the price and manage the demand by calculating and adjusting the assessment structure 224.

The pricing module can have a cost reflection module 624 and a demand management module 626. The cost reflection module 624 is for calculating the assessment structure 224 to directly reflect the cost of providing the resource 103.

The assessment structure 224 can directly reflect the cost by having directly relating the client-usage status 204, the total-usage status 208, and the current production amount 216, to the price, as opposed to a flat fee schedule based only on time and aggregate amount of usage. In doing so, the cost reflection module 624 can use

The cost reflection module 624 can calculate the assessment structure 224 to directly reflect the cost of providing the resource 103 by integrating the client-usage forecast 206, the total-usage forecast 210 with the cost profile 222. The cost reflection module 624 can integrate the client-usage forecast 206, the total-usage forecast 210, or both with the cost profile 222 by calculating the costs related to the client-usage forecast 206 and the total-usage forecast 210.

The cost reflection module 624 can calculate amount of the projected costs that each of the client structures 102 are responsible by using the client-usage forecast 206. The cost reflection module 624 can also calculate the total projected cost using the total-usage forecast 210 and divide projected costs based on the total-usage forecast 210 amongst the client structures 102 or per units of the resource to find the assessment structure 224.

The cost reflection module 624 can identify the various resource output amounts in the total-usage forecast 210 and find the associated cost in the pricing module 606. The cost reflection module 624 can associate the cost for all values of the output amount in the total-usage forecast 210.

The cost reflection module 624 can evenly divide the cost of the projected output amongst the client structures 102. The cost reflection module 624 can also divide the cost by the output amount to find dollars-per-resource unit for the specified output amount.

The cost reflection module 624 can also sub-group the output amounts based on the client-usage forecast 206 to have varying prices per grouped amounts of resources, such as charging higher rates for amounts exceeding threshold amounts. The threshold amounts can be predetermined by the resource management system 100, the consumer, the resource supplier 104, software manufacturer, hardware manufacturer, or a combination thereof.

The cost reflection module 624 can repeat the process for all of the time period covered by the total-usage forecast 210 and aggregate the resulting costs at different times to find the assessment structure 224. Thus, the cost reflection module 624 can divide the actual cost for the resource supplier 104 to calculate the assessment structure 224.

For example, the total-usage forecast 210 can have the expected power output to average 200 MW between 6:00 pm and 9:00 pm for serving 6,000 of the client structures 102. The cost profile 222 can have the cost of providing 200 MW to be $400,000 per hour. The cost reflection module 624 can associate the two matching values to calculate that the electricity company is estimated to have a cost of $400,000 per hour between 6:00 pm and 9:00 pm.

Continuing with the example, the cost reflection module 624 can divide the $400,000 evenly amongst 6,000 consumers and charge each of the client structure $80 per hour between 6:00 pm and 9:00 pm. The cost reflection module 624 can also divide the $400,000 by 200 MW to find $0.002 per one watt-hour between 6:00 pm and 9:00 pm.

Continuing further with the example, the cost reflection module 624 can examine the client-usage forecast 206 of the 6,000 consumers to calculate the assessment structure 224 based on the statistical share of the burden. As a more specific example, 1,000 of the consumers can be expected each average 150 kW and the remaining *4,000 of the consumers can be expected to consume 150 MW of the resources, each averaging 12.5 kW, between 6:00 pm and 9:00 pm. The cost reflection module 624 can set the assessment structure 224 to have higher price for amounts exceeding 12.5 kW to have the consumers having high consumption bear a greater burden of the cost.

The cost reflection module 624 can also calculate the pricing module 606 to directly reflect the cost of providing the resource 103 by using instantaneous feedback through the total-usage status 208 and the client-usage status 204 along with the cost profile 222. The cost reflection module 624 can associate the current cost to the total-usage status 208 based on the cost profile 222. The cost reflection module 624 can divide the current cost using methods similar to the ones described above. The cost reflection module 624 can store costs divided to each of the client structures 102 at each moment for a period of time to calculate the assessment structure 224.

The cost reflection module 624 can increase the divided cost to account for profits, emergency operation cost, training cost, or other overhead costs that are not accounted for in the total-usage forecast 210. For example, the cost reflection module 624 can increase the divided costs by 10% to account for all of the overhead costs. Also, for example, the cost reflection module 624 can add a flat amount representing the actual overhead costs to one or multiple billing cycles and divide the additional amount using similar division methods as described above.

It has been discovered the present invention provides the resource management system 100 with improved cost efficiency. The cost reflection module 624 gives rise to the improved cost efficiency by calculating the assessment structure 224 directly and dynamically related to the cost and thus accurately reflecting the actual cost of providing the energy in the price rather than a flat or predetermined pricing scheme. Market theory can apply to maximize cost efficiency based on the direct relationship between the price and the cost.

The demand management module 626 is for adjusting the pricing module 606 to manage the demand for the resource 103. The demand management module 626 can adjust the assessment structure 224 to manage the demand by increasing or decreasing the prices within the assessment structure 224. The demand management module 626 can also use the client-usage forecast 206, the total-usage forecast 210, the client-usage status 204, the total-usage status 208, or any combination thereof to adjust the assessment structure 224.

For example, the demand management module 626 can increase the prices for electricity during summer to account for the air-conditioners or increase the prices for gas and oil to account for the heating during the winter. Also, for example, the demand management module 626 can decrease the price if the client-usage status 204, the total-usage status 208, or both are below the estimated amounts in the client-usage forecast 206 or the total-usage forecast 210 respectively, or greatly increase the price near the output levels requiring production from a back-up plant.

For further example, the demand management module 626 can increase the price above the accounted cost amounts where the client-usage forecast 206 or the total-usage forecast 210 have an increase in amount greater than a threshold amount. As a more specific example, the demand management module 626 can increase the price 30% wherever the demand for the resource 103 is 125% or greater than the demand during the previous hour according to the client-usage forecast 206 or the total-usage forecast 210.

The demand management module 626 can use various models and algorithms to determine when and how much to adjust the assessment structure 224. For example, the demand management module 626 can adjust the assessment structure 224 seasonally or when the demand exceeds certain thresholds according to the client-usage forecast 206 or the total-usage forecast 210. Also, for example, the demand management module 626 can determine the threshold levels for adjusting the assessment structure 224 or the adjustment amount using human behavior models, economic forecast models, predetermined tables and conditions, user inputs, or any combination thereof.

The demand management module 626 can use the data from a feedback structure in the resource management system 100. The client-usage status 204 over time can serve as the feedback of the adjustments to the assessment structure 224. The demand management module 626 can adjust the assessment structure 224 using the fed back information to have the client-usage status 204 converge to the client-optimization model 218 and the total-usage status 208 to the total-optimization model 220.

In manage the demand for the resource 103, the demand management module 626 can determine the utilization model 422 of FIG. 4. The demand management module 626 can receive the detailed consumption data 402 from the optimization module 608. The demand management module 626 can use the detailed consumption data 402 to determine the utilization model 422 for each of the client structures 102 or each of the members therein.

The demand management module 626 can determine activities or methods by analyzing and processing the detailed consumption data 402 using mathematical models, individual or socio-economic behavioral data, seasonal behavioral data, past trends, previously recorded values of the detailed consumption data 402, or a combination thereof. For example, the demand management module 626 can receive information that shows the dryer operation time for an average house-hold is 55 minutes.

Continuing with the example, the demand management module 626 can determine the utilization model 422 to include decreasing the dryer time by 5 minutes per run for Client A based on the detailed consumption data 402. Also, for example, the demand management module 626 can determine the utilization model 422 to include decreasing the target temperature of Client A's house by 1 degree and delay the on time 30 minutes before the forecasted temperature drop to account for storing the resource 103 before the weather change.

The demand management module 626 can also calculate the incentive 226 of FIG. 2 that can be used to manage the demand using the sensor network 302. The demand management module 626 can calculate the incentive 226 by analyzing the methods available for optimizing the power consumption of the individual client structure based on information from the sensor network 302. The demand management module 626 can query the first device 110 to see if the method is applicable. The demand management module 626 can offer the incentive 226 to the consumer when the method is applicable.

The demand management module 626 can set the amount for the incentive 226 using the amount of the resource 103 that would be saved by the method and the cost profile 222. The demand management module 626 can also use the cost to the consumer in creating the condition for the incentive 226 to calculate the amount of the incentive 226. The demand management module 626 can adjust the assessment structure 224 according to the amount of the incentive 226 when the consumer complies with the conditions for the incentive 226.

For example, the demand management module 626 can analyze whether installing the solar panel 304, the battery bank 306 of FIG. 3, or both is an available method for optimizing electricity. The demand management module 626 can query the first device 110 to check if the methods are already being used. If not, the demand management module 626 can calculate the amount of the resource 103 the method can save using the specification of the devices for the method or the efficiency of the method itself.

Continuing with the example, the calculated amount of saved resource can be used to calculate the cost savings through the cost profile 222. The demand management module 626 can offer to lower the monthly bill by the saved amount as the incentive 226. The demand management module 626 can also look for the consumer's likely expense for implementing the method, such as buying and installing additional hardware, and reduce a percentage of the consumer's expense from the assessment structure 224 as the incentive 226.

The demand management module 626 can also use the behavioral stimulus 228 of FIG. 2 to adjust the demand and the assessment structure 224 using the sensor network 302. The demand management module 626 can receive user profiles, usage data, or both through the first communication unit 516, the second communication unit 536, or both from the sensor network 302. The demand management module 626 can analyze the usage data for behaviors that consume above average amounts of the resource 103 or a significant amount of the client-usage forecast 206.

The demand management module 626 can calculate the amount for the behavioral stimulus 228 using methods similar to calculating the incentive 226. The demand management module 626 can use the usage data from the first device 110 to see if the behavioral stimulus 228 is applicable. The demand management module 626 can adjust the assessment structure 224 with the amount of the behavioral stimulus 228 when the usage data shows that the consumer met the specified conditions.

The demand management module 626 can use the first control unit 512, the second control unit 534, or both to process the data and to adjust the assessment structure 224. The demand management module 626 can access various data, such as the client-usage forecast 206 or the adjustment methods, stored in the first storage unit 514, the second storage unit 546, or both.

The demand management module 626 can adjust the assessment structure 224 to influence the demand for the resource 103. In adjusting the assessment structure 224, the demand management module 626 can modify the current consumption of the resource 103 at the client structures 102 using the assessment structure 224. Also, the demand management module 626 can adjust the assessment structure 224 to converge the client-usage status 204 toward the client-optimization model 218 and the total-usage status 208 toward the total-optimization model 220.

The assessment structure 224 can be fed back to the usage module 602. The usage module 602 can use the assessment structure 224 to better identify the changes in the pattern for the client-usage status 204 and the total-usage status 208. The usage module 602 can also use the assessment structure 224 to better determine the client-usage forecast 206 and the total-usage forecast 210 by factoring in the consumer reactions to the assessment structure 224.

The physical transformation of the client-optimization model 218, such as shifts in the peak-period 212 or adjusting the projected usage, results in movement in the physical world, such as a light being switched off or the battery bank 306 being charged. The movement of the people adjusting the usage pattern and amount can be fed back to the resource management system 100 to further operate the resource management system 100.

For example, the change in demand can be shown in the client-usage status 204, the total-usage status 208, or both, which can update the client-usage forecast 206, the total-usage forecast 210, or both. The adjusted forecasts can change the c client-optimization model 218 to better optimize the use and production of the resource 103 based on the feedback information.

It has been discovered the present invention provides the resource management system 100 with improved resource conservation. The cost reflection module 624 gives rise to the improved resource conservation by adjusting the assessment structure 224 using on the client-usage forecast 206, the total-usage forecast 210, the cost profile 222, user profiles and settings, and the status of the first device 110, or any combination thereof, and thusly using the assessment structure 224 as a motivation used to influence the consumer demand. Market theory can apply to maximize resource conservation based on the relationship between the price, the cost, and market behavior.

The demand management module 626 can also manage the demand for the resource 103 by communicating with the consumer. The demand management module 626 can send warnings to the consumer prior to adjusting the assessment structure 224 or instead of adjusting the assessment structure 224.

For example, the demand management module 626 can cause a warning or a notification to appear on the first display interface 530 of FIG. 5, the second display interface 540 of FIG. 5, or both when the actual status amounts exceed the forecasted amounts. Also, for example, the demand management module 626 can use the first communication unit 516, the second communication unit 536, or both to send email, a text message, initiate automated phone calls, turn on a warning indicator, or any combination thereof when the forecasted amounts are greater than a calculated average or previous amounts.

The optimization module 608 is for calculating the best way to produce and use the resources to minimize the cost associated with production and the usage. The optimization module 608 can calculate the best method by calculating the client-optimization model 218 and the total-optimization model 220 of FIG. 2.

The optimization module 608 can have a consumer-profile module 627, a consumer-optimization module 628, and a provider-optimization module 630. The consumer-profile module 627 is for determining the detailed consumption data 402. The consumer-profile module 627 can use the first control unit 512, the second control unit 534, or a combination thereof to determine the detailed consumption data 402.

The consumer-profile module 627 can determine the user background 404 of FIG. 4, the user profile 406 of FIG. 4, the device profile 408 of FIG. 4, the device-specific usage profile 410 of FIG. 4, the environmental factor 412 of FIG. 4, the subscription plan 414 of FIG. 4, the storage capacity 416 of FIG. 4, or a combination thereof. The consumer-profile module 627 can determine the detailed consumption data 402 by querying or searching various sources for appropriate information.

For example, the consumer-profile module 627 can search the second storage unit 546 for information provided during the initial service request or census data, government registry or databases, survey information, privately owned and publically available databases or webpages, or a combination thereof through the communication network 108. Also, for example, the consumer-profile module 627 can access the sensor network 302, the gateway 308, individual devices or systems within each of the client structures 102, the device or system manufacturers, or a combination thereof.

The consumer-profile module 627 can determine the detailed consumption data 402 by calculating and further processing the received or searched information. For example, the consumer-profile module 627 can calculate the device-specific usage profile 410 or the utilization model 422.

The consumer-profile module 627 can determine the detailed consumption data 402 by combining the received data, searched data, further processed data, or a combination thereof. The consumer-profile module 627 can combine the data according to an order or a format predetermined by the resource management system 100, software or hardware manufacturer, or a combination thereof.

The consumer-profile module 627 can repeat the process for each of the client structures 102 to determine the detailed consumption data 402 corresponding to each of the client structures 102. The consumer-profile module 627 can pass the detailed consumption data 402 to the usage module 602 and the pricing module 606 through the optimization module 608. The consumer forecast module 616, the total forecast module 618, or a combination thereof can use the detailed consumption data 402 to adjust the client-usage forecast 206, the total-usage forecast 210, or a combination thereof.

The consumer-optimization module 628 is for calculating the client-optimization model 218 for each of the client structures 102. The consumer-optimization module 628 can use the client-usage status 204, the assessment structure 224 of FIG. 2, the detailed consumption data 402, or a combination thereof to calculate the client-optimization model 218.

The consumer-optimization module 628 can calculate the client-optimization model 218 by adjusting the client-usage forecast 206 based on the assessment structure 224. For example, the consumer-optimization module 628 can adjust the client-usage forecast 206 by increasing the usage where the client-usage forecast 206 has the lowest consumption, decreasing the usage where the client-usage forecast 206 has the highest consumption, or both to calculate the client-optimization model 218.

Also, for example, the consumer-optimization module 628 can also perform peak detection on the client-usage forecast 206. The consumer-optimization module 628 can decrease the usage amounts near each peak to calculate the client-optimization model 218.

For further example, the consumer-optimization module 628 can also identify the consumption amounts that have a large jump in price within the assessment structure 224. The consumer-optimization module 628 can identify regions in the client-usage forecast 206 that have slightly higher consumption amount than the identified areas with large increase in price. The consumer-optimization module 628 can lower the consumption levels below the regions having the rapid increase in price to calculate the client-optimization model 218.

The amount of increase or decrease can be proportionate to the amount in the client-usage forecast 206. The amount of increase or decrease can also be designated by the difference in amount to where the assessment structure 224 has a steep decline.

The amounts and the thresholds for determining whether to adjust can be determined by the consumer-optimization module 628. The consumer-optimization module 628 can determine the threshold levels for finding where to adjust within the client-usage forecast 206 to calculate the client-optimization model 218 by using human behavior models, economic forecast models, predetermined tables and conditions, user inputs, or any combination thereof.

The consumer-optimization module 628 can also adjust the client-usage forecast 206 by increasing the resource consumption when the assessment structure 224 is the lowest or below a threshold level and the first device 110 has or is connected to the battery bank 306 of FIG. 3. The consumer-optimization module 628 can calculate the client-optimization model 218 by increasing the flow of the resource 103 into the client structures 102 to be stored in the battery bank 306 when the price is the cheapest.

The consumer-optimization module 628 can adjust the client-usage forecast 206 by decreasing the resource consumption during the peak-period 212 of FIG. 2. The consumer-optimization module 628 can also schedule the use of the stored resources in the battery bank 306 during the peak-period 212. The consumer-optimization module 628 can similarly account for the solar panel 304 of FIG. 3.

The consumer-optimization module 628 can also use feedbacks from the first device 110 for data such as user settings, profiles, or device status to calculate the client-optimization model 218. For example, if the consumer is older than 65 or if there is an occupant within the structure, the consumer-optimization module 628 can decrease the adjustment magnitude of the temperature.

The provider-optimization module 630 is for calculating the total-optimization model 220 for the resource supplier 104. The provider-optimization module 630 can calculate the total-optimization model 220 by summing the client-optimization model 218 for all of the client structures 102. The provider-optimization module 630 can also use similar methods as described for the consumer-optimization module 628 to calculate the total-optimization model 220.

The provider-optimization module 630 can also use the assessment structure 224 to calculate the total-optimization model 220 for the resource supplier 104. The provider-optimization module 630 can increase or decrease the total-usage forecast 210 based on the assessment structure 224 using methods similar as described for the consumer-optimization module 628.

The provider-optimization module 630 can also calculate the total-optimization model 220 by determining the set of activities in utilization model 422 that best optimize consumption of the resource 103 for different groupings of the client structures 102, the resource supplier 104, or a combination thereof. The provider-optimization module 630 can select the activities or methods for groupings of the client structures 102 that will optimize the amount of resource being produced at the resource supplier 104.

For example, the individual values of the client-optimization model 218 for the client structures 102 may not optimize power consumption at greater groupings, such as for a community or a state. The provider-optimization module 630 can calculate the total-optimization model 220, which can be used to adjust the client-optimization model 218, to optimize power consumption for different groupings of the client structures 102. The resource management system can further use the total-optimization model 220 and the client-optimization model 218 to optimize the production of the resource 103.

The provider-optimization module 630 can identify the activities, methods, or behaviors of individual members of each of the client structures 102 that can reduce the consumption of the resource 103 from the output of the consumer-optimization module 628. The provider-optimization module 630 can balance the identified activities, methods, or behaviors of each individual member to modify the consumption of the client structures 102 to optimize the production of the resource 103 at the resource supplier 104.

For example, the provider-optimization module 630 can identify that reducing dryer cycle time for the client structures 102 can reduce the amount of electricity produced at the resource supplier 104. Also, for example, the provider-optimization module 630 can schedule optimal time for each of the client structures 102 to optimize the electricity needed for a group of client structures 102. The provider-optimization module 630 can calculate the total-optimization model 220 by scheduling the consumption activities, such as using the washer or dryer for the client structures 102.

The provider-optimization module 630 can determine ideal time or schedule for consuming the resource 103 at each of the client structures 102 within a grouping to optimize the production level. For example, the provider-optimization module 630 can schedule 30% of the houses within a development to do the laundry in the mornings over the weekend, 30% in the afternoon, and 10% in the evening based on the detailed consumption data 402 of each house. Also, for example, the provider-optimization module 630 can schedule 20% of the households to use the washer and dryer during the week.

The provider-optimization module 630 can also use the detailed consumption data 402, the client-usage forecast 206, the total usage forecast 210, or a combination thereof to balance the source of consumption for each of the client structures 102. The provider-optimization module 630 can determine a schedule for using the battery bank 306, the solar panel 304, or a combination thereof to supply the resource 103 that can optimize the production of the resource 103 at the resource supplier 104. The provider-optimization module 630 can determine a schedule for charging the battery bank 306 to optimize production.

For example, the provider-optimization module 630 can calculate the calculate the total-optimization model 220 to include a schedule for using and charging alternative sources to optimize the production level for a winter storm forecasted to arrive in three days. The provider-optimization module 630 can lower the reliance on the solar panel 304 during the forecasted period for the storm and increase the charging time or amount before the forecasted arrival of the storm.

The provider-optimization module 630 can pass the total-optimization model 220 to the consumer-optimization module 628. The consumer-optimization module 628 can adjust the client-optimization model 218 to conform to the total-optimization model 220. The consumer-optimization module 628 can pass the client-optimization model 218 and the total-optimization model 220 to the pricing module 606. The pricing module 606 can recalculate and adjust the assessment structure 224, the incentive 226, the behavioral stimulus 228 or a combination thereof as described above to provide a benefit to the client structures 102 for cooperatively conforming to the total-optimization model 220.

The provider-optimization module 630 can also pass the total-optimization model 220 to the pricing module 606 directly. The pricing module 606 can recalculate and adjust the assessment structure 224, the incentive 226, the behavioral stimulus 228 or a combination thereof as described above to provide a benefit to the client structures 102 for cooperatively conforming to the total-optimization model 220.

The implementation module 610 is for implementing methods to have the client-usage status 204, the total-usage status 208, or both converge to the client-optimization model 218 and the total-optimization model 220 respectively. Methods can include using the first device 110 to control the appliances, the conduits for the resource 103, such as the faucet or the electrical outlet, the lights, heating or cooling systems, the battery bank 306, the solar panel 304, or any combination thereof within the client structures 102.

For example, the resource management system 100 can directly control the various devices and systems that consume the resource 103 within the client structures 102 through the first device 110. As a more specific example, the implementation module 610 can turn off the lights in unoccupied rooms, implement the charging and usage of the battery bank 306, or pre-heat or pre-cool before the peak-period 212.

The implementation module 610 can directly control the current consumption of the resource 103 at the client structures 102 using the assessment structure 224 and the client-usage status 204. For example, the implementation module 610 can turn off the refrigerators or adjust the thermostat when the client usage status 204 is contributing to the back-up plant coming on-line.

Also, for example, the implementation module 610 can charge the battery bank 306 when the assessment structure 224 is at the lowest. The implementation module 610 can have the client structure 102 use the resource 103 stored in the battery bank 306 and not the resource 103 from the resource supplier 104 when the client-usage status 204 is high or when the assessment structure 224 is at the peak, or both.

Other methods can include notifying the consumer when the client-usage status 204 and the usage trend indicate the consumption level will cause a steep increase in price according to the assessment structure 224. For example, the implementation module 610 can use the first communication unit 516, the second communication unit 536, or both to send emails, text messages, pre-recorded voice messages, or a combination thereof. Also, for example, the implementation module 610 can display warning messages on the first display interface 530, the second display interface 540, or both.

The consumer-optimization module 628 can use the detailed consumption data 402 to calculate the client-optimization model 218. The consumer-optimization module 628 can analyze the detailed usage data according to each member, each device or system, or a combination thereof for each of the client structures 102.

For example, the consumer-optimization module 628 can determine who has a habit of leaving the facet running while they brush their teeth or not turn-off the lights when they leave a room. Also, for example, the consumer-optimization module 628 can determine when to start charging the battery bank 306 according to the temperature preference and the weather forecast.

It has been discovered that the present invention provides the resource management system 100 with improved conservation of the resource 103. The combination of the implementation module 610 and the first device 110 gives rise to the improved conservation by directly controlling the consumption aspects of the client structures 102 to mimic the client-optimization model 218.

It has also been discovered that the present invention provides the resource management system 100 with improved price efficiency of the client structures 102. The combination of the optimization module 608, the implementation module 610 and the first device 110 gives rise to the improved price efficiency by directly monitoring the usage of the resource 103 and controlling the usage to minimize the bill using the assessment structure 224.

It has further been discovered that the present invention provides improved conservation and price efficiency for the client structures 102 and the resource supplier 104. The detailed consumption data 402, the gateway 308, and the sensor network 302 provide improved conservation and price efficiency by allow the resource management system 100 to gather device or system specific and personalized usage data. The resource management system 100 can use the detailed consumption data 402 to optimize the usage pattern at personal and device-specific level and influence the client's behavior at personal and device-specific level.

The resource management system 100 can have the modules partitioned and operating differently. For example, the current-cost module 622 can calculate the current production amount 216 using the total-usage status 208 using past or present values for the expenses and budget reports. The cost-profile module 620 can store and track the current production amount 216 at different output levels. The cost-profile module 620 can compile the values of the current production amount 216 for different output levels to calculate the cost profile 222.

The various modules described above, such as the current-consumer module 612 or the implementation module 610, can further be hardware implementation as a specialized hardware accelerators within the first control unit 512, the second control unit 534, or both. The various modules can also be hardware implementation in the first device 110, the second device 112, or both, outside of the first control unit 512 and the second control unit 534.

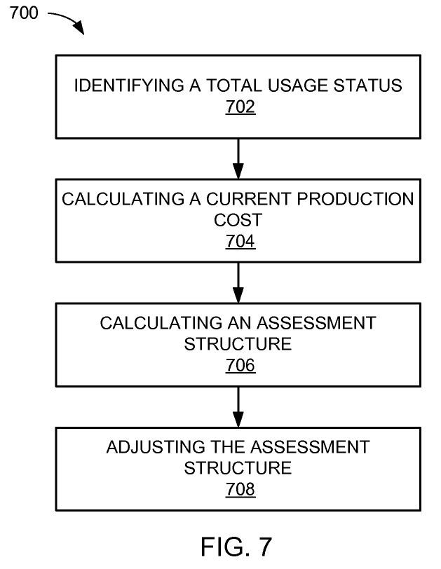

Referring now to FIG. 7, therein is shown a flow chart of a method 700 of operation of the resource management system 100. The method 700 includes: identifying a total-usage status of a resource currently being supplied in a block 702; calculating a current production amount of supplying the resource using the total-usage status in a block 704; calculating an assessment structure directly reflecting the current production amount in a block 706; and adjusting the assessment structure for modifying behavior associated with the current consumption of the resource in a block 708.

Yet other important aspects of the embodiments include that it valuably supports and services the historical trend of reducing costs, simplifying systems, and increasing performance.

These and other valuable aspects of the embodiments consequently further the state of the technology to at least the next level.

Thus, it has been discovered that the resource management system of the present invention furnishes important and heretofore unknown and unavailable solutions, capabilities, and functional aspects for improving reliability in systems. The resulting processes and configurations are straightforward, cost-effective, uncomplicated, highly versatile, and effective, can be implemented by adapting known technologies, and are thus readily suited for efficiently and economically implementing a resource management system.

While the invention has been described in conjunction with a specific best mode, it is to be understood that many alternatives, modifications, and variations will be apparent to those skilled in the art in light of the aforegoing description. Accordingly, it is intended to embrace all such alternatives, modifications, and variations that fall within the scope of the included claims. All matters hithertofore set forth herein or shown in the accompanying drawings are to be interpreted in an illustrative and non-limiting sense.

What is claimed is:

1. A method for operating a resource management system comprising:
identifying a total-usage status of a resource currently being supplied;
calculating a current production amount of supplying the resource using the total-usage status;
calculating an assessment structure directly reflecting the current production amount; and
adjusting the assessment structure for modifying behavior associated with the current consumption of the resource.

2. The method as claimed in claim 1 further comprising:
identifying a client-usage status of the resource;
calculating a client-optimization model using the client-usage status; and
adjusting the assessment structure to converge the client-usage status toward the client-optimization model.

3. The method as claimed in claim 1 further comprising:
calculating a total-optimization model; and
adjusting the assessment structure to converge the total-usage status toward the total-optimization model.

4. The method as claimed in claim 1 further comprising:
determining a client-usage forecast using a sensor network; and
wherein calculating the assessment structure includes:
calculating the assessment structure using the client-usage forecast.

5. The method as claimed in claim 1 further comprising:
determining a total-usage forecast; and
adjusting the assessment structure using the total-usage forecast.

6. A method of operating a resource management system comprising:
identifying a client-usage status of a resource currently being consumed using a sensor network;
identifying a total-usage status of the resource currently being supplied;
calculating a current production amount of supplying the resource using the total-usage status;
calculating an assessment structure directly reflecting the current production amount; and
controlling the current consumption of the resource using the assessment structure and the client-usage status.

7. The method as claimed in claim 6 further comprising:
calculating a client-optimization model using the assessment structure; and
wherein controlling the consumption includes:
controlling the consumption of the resource to have the client-usage status converge toward the client-optimization model.

8. The method as claimed in claim 6 further comprising:
calculating a total-optimization model using the assessment structure; and
wherein controlling the consumption includes:
controlling the current consumption of the resource to have the total-usage status converge toward the total-optimization model.

9. The method as claimed in claim 6 wherein calculating the assessment structure includes calculating an incentive using the sensor network.

10. The method as claimed in claim 6 rein calculating the assessment structure includes calculating a behavioral stimulus using the sensor network.

11. A resource management system comprising:
a current-total module for identifying a total-usage status of a resource currently being supplied;
a current-cost module, coupled to the current-total module, for calculating a current production amount of supplying the resource using the total-usage status;
a cost reflection module, coupled to the current-cost module, for calculating an assessment structure directly reflecting the current production amount; and
a demand management module, coupled to the current-cost module, adjusting the assessment structure for modifying behavior associated with the current consumption of the resource.

12. The system as claimed in claim 11 further comprising:
a current-consumer module, coupled to the current-total module, for identifying a client-usage status of the resource;
a consumer-optimization module, coupled to the cost reflection module, for calculating a client-optimization model using the client-usage status; and
wherein:
the demand management module is for adjusting the assessment structure to converge the client-usage status toward the client-optimization model.

13. The system as claimed in claim 11 further comprising:
a provider-optimization module, coupled to the cost reflection module, for calculating a total-optimization model; and
wherein:
the demand management module is for adjusting the assessment structure to converge the total-usage status toward the total-optimization model.

14. The system as claimed in claim 11 further comprising:
a consumer forecast module, coupled to the current-consumer module, for determining a client-usage forecast using a sensor network; and
wherein:
the cost reflection module is for calculating the assessment structure using the client-usage forecast.

15. The system as claimed in claim 11 further comprising:
a total forecast module, coupled to the current-consumer module, for determining a total-usage forecast; and
wherein:
the cost reflection module is for adjusting the assessment structure using the total-usage forecast.

16. The system as claimed in claim 11 further comprising:
a current-consumer module, coupled to the current-total module, for identifying a client-usage status of a resource currently being consumed using a sensor network; and
an implementation module, coupled to the cost reflection module, for controlling the current consumption of the resource using the assessment structure and the client-usage status.

17. The system as claimed in claim 16 further comprising:
a consumer-optimization module, coupled to the cost reflection module, for calculating a client-optimization model using the assessment structure; and
wherein:
the implementation module is for controlling the consumption of the resource to have the client-usage status converge toward the client-optimization model.

18. The system as claimed in claim 16 further comprising:
a provider-optimization module, coupled to the cost reflection module, for calculating a total-optimization model using the assessment structure;
wherein:
the implementation module is for controlling the current consumption of the resource to have the total-usage status converge toward the total-optimization model.

19. The system as claimed in claim 16 further comprising a demand management module, coupled to the current-cost module, for calculating an incentive using the sensor network.

20. The system as claimed in claim 16 further comprising a demand management module, coupled to the current-cost module, for calculating a behavioral stimulus using the sensor network.
